(19) United States
(12) Patent Application Publication
(10) Pub. No.: US 2021/0254799 A1
(43) Pub. Date: Aug. 19, 2021

(54) ILLUMINATION SYSTEM WITH HIGH INTENSITY OUTPUT MECHANISM AND METHOD OF OPERATION THEREOF

(71) Applicant: Optonomous Technologies, Inc., Agoura Hills, CA (US)

(72) Inventors: Yung Peng Chang, Hsinchu (TW); Alan Wang, Taichung (TW); Kirk Huang, Taichung (TW); Mark Chang, Taichung (TW); Lion Wang, Hsinchu (TW); Andy Chen, Taichung (TW); Kenneth Li, Agoura Hills, CA (US)

(21) Appl. No.: 17/252,245

(22) PCT Filed: Jun. 14, 2019
(86) PCT No.: PCT/US19/37231

§ 371 Date: Dec. 14, 2020

Related U.S. Application Data
(60) Provisional application No. 62/763,423, filed on Jun. 14, 2018.

(51) Int. Cl. F21K 9/61; F21S 41/176; F21V 29/502; F21V 9/32

(52) U.S. Cl. CPC F21K 9/61; F21S 41/176; F21Y 2115/30; F21V 9/32; F21V 29/502

(57) ABSTRACT

An illumination system includes a waveguide having a first end configured to receive a laser light, a luminescent portion configured to generate a luminescent light from the laser light, a second end opposite the first end; an input device configured to collect the laser light for propagation to the first end; an output device adjacent to the second end configured to reflect at least some of the laser light back into the luminescent portion and direct the luminescent light away from the second end through an output surface. In one embodiment, the input device includes a light homogenizer configured to receive the laser light and provide to the first end of the waveguide a spatially uniform intensity distribution of the laser light. In another embodiment, a heat dissipater is provided adjacent to the waveguide and configured to dissipate heat generated within the waveguide by the generation of the luminescent light.

### CROSS-REFERENCE TO RELATED APPLICATION

This application claims the benefit of U.S. Provisional Patent Application Ser. No. 62/763,423 filed Jun. 14, 2018, and the subject matter thereof is incorporated herein by reference thereto. This application claims the benefit of U.S. Provisional Patent Application Ser. No. 62/764,085 filed Jul. 18, 2018, and the subject matter thereof is incorporated herein by reference thereto. This application claims the benefit of U.S. Provisional Patent Application Ser. No. 62/766,209 filed Oct. 5, 2018, and the subject matter thereof is incorporated herein by reference thereto.

### TECHNICAL FIELD

An embodiment of the present invention relates generally to a lighting system, and more particularly to a system for generating high intensity luminescent light.

### BACKGROUND

The most widely used light sources for projection systems, spotlights, and automotive headlights are discharge lamps. The discharge lamps can include mercury vapor lamps, metal halide lamps, high pressure sodium lamps, low pressure sodium lamps, or the like. The lighting systems that use the discharge lamps require fixtures that are physically large and able to dissipate the heat generated by an electric arc at the heart of the light. Over time, these lights can deteriorate to lose as much as 70% of their efficiency in light generated per Watt consumed. The discharge lamps are capable of high intensity output, but they also provide poor luminous efficacy. Discharge lamps have the drawbacks of high-power requirements, short lifetime, high cost, and use of mercury, which is an environmental hazard.

Thus, a need still remains for a lighting system with high intensity output mechanism to provide improved light generation, reliability, and flexibility. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an apparatus, and an illumination system, including: a waveguide having a first end configured to receive a laser light, a luminescent portion configured to generate a luminescent light from the laser light, and a second end opposite the first end configured to pass the luminescent light; an input device adjacent to the first end configured to collect the laser light for propagation to the first end; an output device adjacent to the second end configured to reflect at least some of the laser light back into the luminescent portion and direct the luminescent light away from the second end through an output surface. In one embodiment, the input device includes a light homogenizer configured to receive the laser light and provide to the first end of the waveguide a spatially uniform intensity distribution of the laser light. In another embodiment, the system includes heat dissipater positioned adjacent to the waveguide, configured to dissipate heat generated within the waveguide by the generation of the luminescent light.

An embodiment of the present invention provides a method that includes sourcing a laser light into an input device adjacent to a waveguide, the waveguide including: receiving a laser light through a first end, generating a luminescent light from the laser light in a luminescent portion, passing the luminescent light through a second end; propagating the laser light into the first end of the waveguide; reflecting at least some of the laser light back into the luminescent portion; directing the luminescent light away from the second end through an output surface. In one embodiment, the method further includes homogenizing the laser light, and directing to the first end of the waveguide a spatially uniform intensity distribution of the laser light. In another embodiment, the method further includes dissipating heat generated within the waveguide by the generation of the luminescent light.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an example of a functional block diagram of an illumination system with high intensity output mechanism in an embodiment of the present invention.

FIG. 2 is an example of a functional block diagram of an illumination system with high intensity output mechanism in an alternative embodiment.

FIG. 3 is an example of a functional block diagram of an illumination system with high intensity output mechanism in yet another alternative embodiment.

FIG. 4 is an example configuration of a heat sink adjacent to a crystal phosphor wave guide in an embodiment.

FIG. 5 is an example of a functional block diagram of an illumination system with high intensity output in yet another alternative embodiment.

FIG. 6 is a flow chart of a method of operation of an illumination system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “adjacent” referred to herein can be defined as two elements in close proximity to each other. The terms “on” and “abut” referred to herein can be defined as two elements in physical contact with no intervening elements.

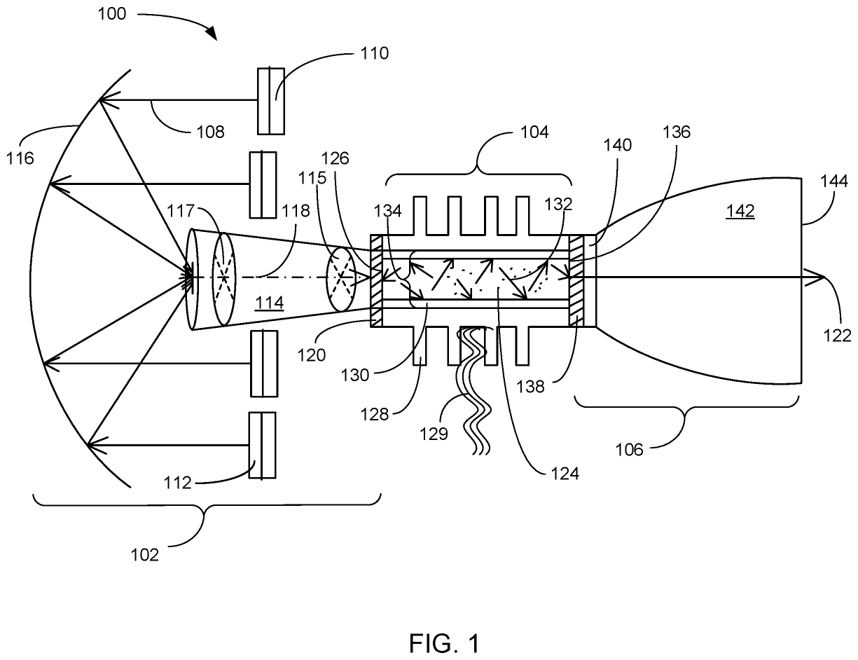

Referring now to FIG. 1, therein is shown an example of a functional block diagram of an illumination system 100 with thermal performance mechanism in one embodiment of the present invention. The illumination system 100 is depicted as an input device 102, a waveguide assembly 104, and an output device 106.

The input device 102 can be a hardware structure configured to collect laser light 108 sources for a laser array 110, or a single laser, including a collimating lens array 112, and focus the output of the laser array 110 on a light homogenizer 114. The light homogenizer 114 is any optical structure configured to provide a spatially uniform light intensity distribution of the laser light 108 to a first end 126 of a crystal phosphor waveguide 134. The first end 126 of the crystal phosphor waveguide 134 is located proximate the light homogenizer 114 and a second end 136 of the crystal phosphor waveguide 134 is opposite the first end 126. The crystal phosphor waveguide 134 can be any physical structure that is capable of containing and directing waves, such as light waves, with minimal loss of energy.

The light homogenizer 114 can be an optical structure for equalizing the spatial intensity distribution of the laser light 108. As an example, the light homogenizer 114 can be a light pipe, a glass tube, or a light tube, and be formed of a solid piece of dense quartz glass or similar material having the characteristic of homogenizing the intensity distribution of the laser light 108. The collimating lens array 112 is an optical device that includes surface features that accept light in a non-parallel direction and produces a light output with a parallel columns or waves evenly distributed across the optical path.

By way of an example, the input device 102 can utilize a parabolic reflector 116 to redirect the laser light 108 to an axial centerline 118 of the light homogenizer 114. The parabolic reflector 116 can be a reflective surface formed in a parabolic shape for collecting the laser light 108 and focus the laser light 108 on the axial centerline 118 of the optical path. The axial centerline 118 can be defined to be the center of the optical path through the illumination system 100.

The light homogenizer 114 can include an output cross-section 115 that can be equal in size and shape to a waveguide 134. The light homogenizer 114 can also include an input cross-section 117 that can be larger or smaller than the output cross-section 115 and the waveguide 134.

An input filter 120 can include a glass plate, plastic or filter coated with a dichroic film to pass the laser light 108 and reflect a luminescent light 122 that is generated within a luminescent portion 124 when the laser light 108 enters the crystal phosphor waveguide assembly 104. The glass plate with dichroic coating can also be replaced by directly coating the output end of the light homogenizer 114 or the input end of the crystal phosphor waveguide assembly 104. The luminescent portion 124 can be a crystalline structure that absorbs the energy input of the laser light 108 and producing the luminescent light 122. As an example, the luminescent portion 124 can be a crystal phosphor rod with refractive index of 1.8, the light projected through the CPC 142 with refractive index of 1.5 and into the air, with refractive index of n=1.0.

The input filter 120 can be a device that selectively transmits light of different wavelengths, and can be implemented as a dichroic glass plate or plastic device in the optical path. The input filter 120 can be configured to pass the laser light 108 and reflect the luminescent light 122. The input filter 120 can be attached directly on a first end 126 of the waveguide assembly 104. The waveguide assembly 104 includes the luminescent portion 124, a heat dissipater 128 adjacent to the luminescent portion 124, and an intermediate layer 130.

As an example, the intermediate layer 130 can be formed directly on the luminescent portion 124, the heat dissipater 128, or a combination thereof. The heat dissipater 128 can be a heat sink formed of a thermally conductive material, such as aluminum, copper, ceramic, or any suitable thermal conductor. The intermediate layer 130 can be a layer of liquid, gel, poly-silicon glass, a coating of silver, aluminum, magnesium oxide, barium sulfate, or any suitable material for reflecting an incident luminous light 132 back into the luminescent portion 124 and conduct or transfer heat, formed in the crystal phosphor waveguide 134, to the heat dissipater 128. The crystal phosphor waveguide 134 can include and be formed of the luminescent portion 124 and the intermediate layer 130. The crystal phosphor waveguide 134 can be configured to be stimulated or excited by the laser light 108 to produce the luminescent light 122 which can be adjusted to project various specific colors of the luminescent light 122.

When the laser light 108 passes through the input filter 120, the laser light 108 can stimulate the luminescent portion 124 to generate the luminescent light 122. The waveguide 134 can capture the incident luminous light 132 and direct it toward the second end 136, of the waveguide 134. An output filter 138 can be formed on the second end 136 of the waveguide 134 and to cover the second end 136 of the waveguide assembly 104. The output filter 138 can be part of the output device 106 and be formed of a material such as plastic or glass that reflects the laser light 108, that hasn't been consumed by stimulating the luminescent portion 124, back into the luminescent portion 124 and passes the luminescent light 122 out of the waveguide assembly 104.

The output device 106 can also include an adaptor layer 140, such as an epoxy coupler, an air gap, a glass spacer, direct fusion between the glass CPC 142 and crystal phosphor waveguide 134, or the like. The adaptor layer 140 can be applied to or formed on the output filter 138 and an optical concentrator, such as a simple parabolic concentrator or a Compound Parabolic Concentrator (CPC) 142. The CPC 142 can bridge the index of refraction of luminescent light 122 passing from the output filter 138 to the CPC 142. The luminescent light 122 that emanates from the output filter 138 can be transferred through the adaptor layer 140 and the CPC 142 to an output surface 144 for applications requiring high output power such as projectors, spotlights, automobile headlights, entertainment systems and the like.

It has been discovered that an embodiment of the illumination system 100 provides waveguide assembly 104 that can enable high efficiency operations when the heat dissipater 128 is used to transfer the heat 129 away from the luminescent portion 124. The inside of the heat dissipater 128 can have the reflective coating 130 such that light escaping from the luminescent portion 124 is reflected back into the luminescent portion 124 for increasing the amount of the luminescent light 122 projected from the output surface 144. The intermediate layer 130 can also be coated on the surface of the luminescent portion 124 to increase the efficiency of conversion of the laser light 108 to the luminescent light 122.

To further increase the amount of the luminescent light 122 projected through the output surface 144, the input filter 120 can be placed at the input of the luminescent portion 124 configured to pass the laser light 108, such as a blue laser light, for excitation and reflecting the incident luminous light 132 back into the luminescent portion 124. The output filter 138 can also be added such that the reflecting the un-absorbed laser light 108 back into the luminescent portion 124 for further excitation and passing the luminescent light 122 to the output surface 144. The output filter 138 can be a blue reflector that can be adjusted or configured such that a small amount of the laser light 108 can be mixed with the luminescent light 122, giving the desired color temperature.

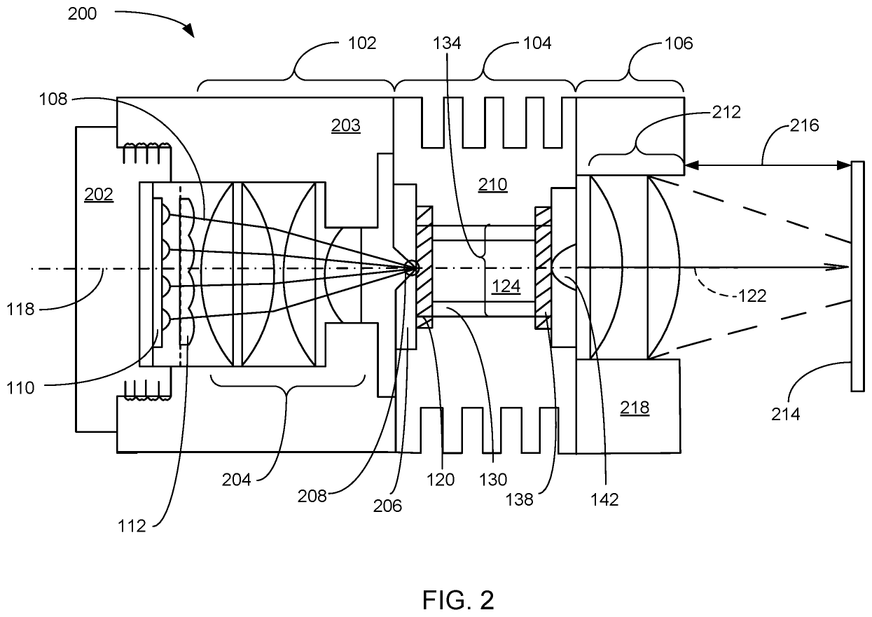

Referring now to FIG. 2, therein is shown an example of a functional block diagram of an illumination system 200 in an alternative embodiment. The functional block diagram of the illumination system 200 depicts the input device 102 with the laser array 110 and the collimating lens array 112 centered on the axial centerline 118. The collimating lens array 112 is an optical device that includes surface features that accept the laser light 108 and produces a light output with a substantially parallel columns or waves.

A heat sink 202 for the laser array can position the laser array 110 relative to the axial centerline 118 in an input frame 203. The input frame 203 can be formed of metal, ceramic, silicon, or plastic, and can provide a flexible platform for a focusing lens structure 204. The input device 102 can include the focusing lens structure 204, mounted in the input frame 203, configured to focus the laser light 108 on to the crystal phosphor waveguide 134. A hollow waveguide 206 can be utilized as the light homogenizer 114 to prepare and direct the laser light 108 to the luminescent portion 124. In this way, the homogenized laser light 108 is received by a larger area of the luminescent portion 124 and causes more excitation of the luminescent portion 124 upon the first pass of the laser light 108 within the crystal phosphor waveguide 134. The focusing lens structure 204 can include a number of lenses that can converge the laser light 108 into the crystal phosphor waveguide 134.

The waveguide assembly 104 can include an input filter 120. The waveguide heat dissipator 210 can form a heat sink 210 for the crystal phosphor waveguide 134.

The waveguide heat dissipater 210 can also include the luminescent portion 124, the intermediate layer 130, the input filter 120, the output filter 138, and a compound parabolic concentrator (CPC) 142. It is understood that in a manufacturing environment, the waveguide assembly 104 can be fabricated and tested prior to assembly with the input device 102 and the output device 106 thus increasing manufacturing efficiency and reducing costs.

The output device 106 can include a projection lens structure 212 configured to collect the luminescent light 122 from the CPC 142 and project the luminescent light 122 on a target surface 214. The size and spacing of the lenses in the projection lens structure 212 can be adjusted or configured to accommodate the distance 216 from the projection lens structure 212 to the target surface 214. The waveguide heat dissipater 210 can be assembled in physical contact with the input frame 203 and a projection frame 218. The projection frame 218 can be fabricated of metal, ceramic, silicon or plastic and is designed to manage the spacing and alignment of the projection lens structure 212.

It has been discovered that the ability to manufacture and test the input device 102, waveguide assembly 104, and the output device 106 prior to assembly can enhance the manufacturing yield and reduce costs of the illumination system 200. The reduction in the amount of the heat 129 provided by the input frame 203, the waveguide heat dissipater 210, and the projection frame 218, can deliver brighter amounts of the luminescent light 122 in a reliable and sustainable manner. The illumination system 200 can produce brighter levels of the luminescent light 122 and have a longer product life.

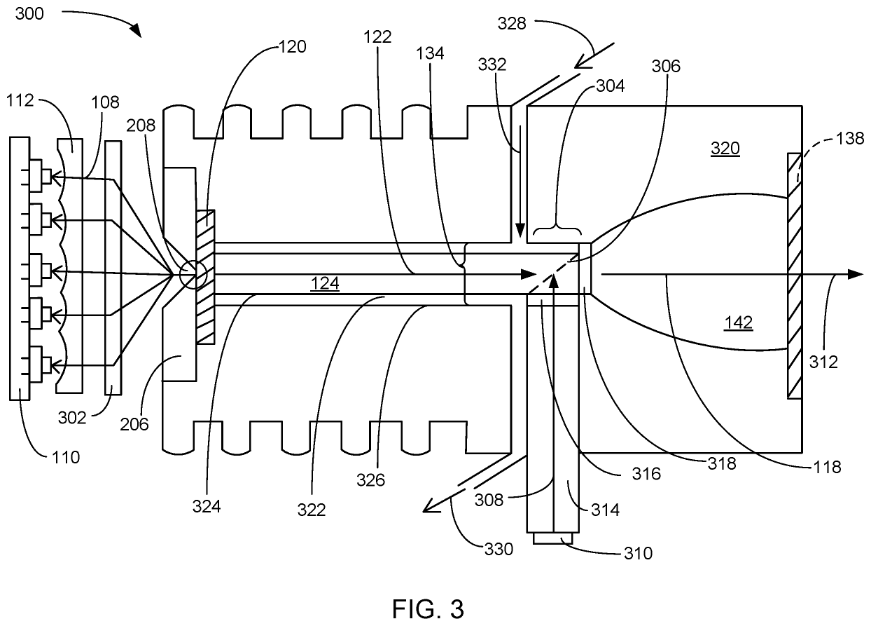

Referring now to FIG. 3, therein is shown an example of a functional block diagram of an illumination system 300 in yet another alternative embodiment. The functional block diagram of the illumination system 300 depicts the laser array 110 positioned adjacent to the collimating lens array 112. The laser light 108 can be propagated from the collimating lens array 112 to a focusing lens structure 302. The focusing lens structure 302 can be a single lens or a set of lenses configured to focus the laser light 108 on the opening 208 of the aperture plate 206.

The luminescent portion 124 of the waveguide 134 can include a beam combiner 304 that can be formed by embedding a reflective filter 306 in the luminescent portion 124. The reflective filter 306 can be a blue reflective filter for shifting the color temperature of the luminescent light 122. The beam combiner 304 can pass the luminescent light 122 and combine a colored light 308 that can be reflected, by the reflective filter 306, into the axial centerline 118.

By way of an example, when the luminescent portion 124 is a crystal phosphorous rod, the luminescent portion 124 can produce the luminescent light 122, being of a yellow light, when stimulated by the laser light 108, being of a blue light. The beam combiner 304 can pass the luminescent light 122 and combine the colored light 308, such as a blue light sourced from an LED 310 or a blue LED. The result is a projected light 312, being a white projected light. The colored light 308 can be transmitted through a light pipe 314, such as a clear glass tube, to the beam combiner 304. A reflection equalizer 316, such as an air gap, or other less dense material that can block a direct reflection of the colored light 308 can assure the correct amount of the colored light 308 can be mixed with the luminescent light 122. The beam combiner 304 can produce the projected light 312 in the axial centerline 118.

The output of the beam combiner 304 can be attached to an adaptor layer 318, such as an air gap, an epoxy coupler, or fused glass. The adaptor layer 318 provides a match, of the index of reflection and index of refraction, for the projected light 312 entering the CPC 142. It is understood that the brightness of the luminescent light 122 is not reduced by the combining of colored lights and the color temperature can reliably be shifted to achieve the color intensity that is desired.

An output end of the CPC 142 can be directly coupled to the output filter 138. In this case, the projected light 312 can pass through the output filter, but residual of the laser light 108 is reflected back into the beam combiner 304. The CPC 142 can be mounted in a thermally conductive frame 320. The thermally conductive frame 320 can be manufactured of metal, ceramic, colored glass, or the like. A cooling gap 322 can surround the luminescent portion 124 along a longitudinal surface 324. The cooling gap 322 also borders an interior surface 326 of the thermally conductive frame 320 in order to transfer the heat 129 generated in the waveguide 134 to the thermally conductive frame 320 by using one of conduction, convection and radiation. The cooling gap 322 can be open to an input port 328 and an output port 330. The purpose of the input port 328, the cooling gap 322, and the output port 330 is to provide a path for air or fluid 332 that can circulate through the cooling gap 322. The fluid 332 can have an index of refraction lower than an index of refraction of the waveguide 134 so as to assist in generating internal reflections of the luminescent light within the waveguide 134 and reducing the need for a reflective coating on the waveguide 134.

It has been discovered that by placing the reflective filter 306 at a 45-degree angle to the axial centerline 118 and the direction of flow of the colored light 308, different color temperatures can be produced as the projected light 312, with high reliability. It has further been discovered that the illumination system 300 can reliably produce the projected light 312 at the desired color temperature range. The cooling of the luminescent portion 124, the beam combiner 304, and the thermally conductive frame 320 can provide a low cost, highly reliable, and flexible source of the projected light 312.

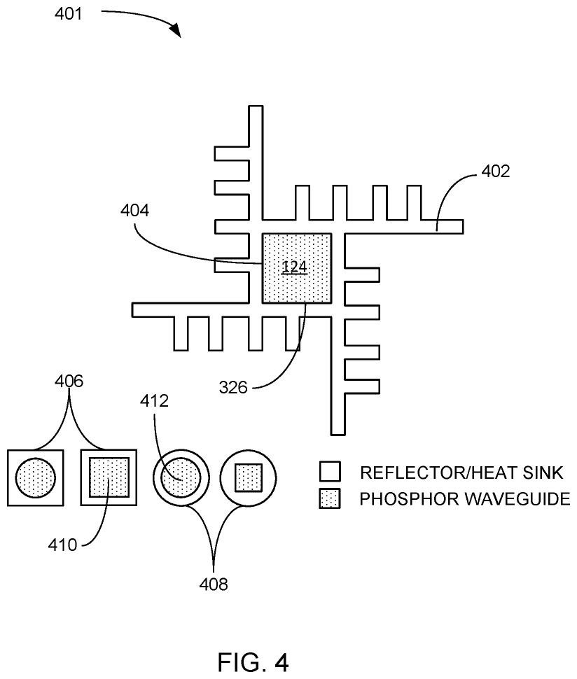

Referring now to FIG. 4, therein is shown an example configuration of a heat sink 401 adjacent to a crystal phosphor waveguide 134 in an embodiment. The example configuration of the heat sink 401 depicts a conductive frame 402 adjacent to the luminescent portion 124. The conductive frame 402 can have the interior surface 326 that has been polished or plated with a reflective material 404, such as a coating of silver, aluminum, magnesium oxide, barium sulfate, or any suitable material that will reflect an incident luminous light 132 of FIG. 1 back into the luminescent portion 124 and conduct the heat 129 of FIG. 1 away from the luminescent portion 124. The reflective material 404 could be plated on the interior surface 326 of the conductive frame 402.

Various other configurations of the heat sink 401 can include the conductive frame 402 shown as a rectangle 406 and a circular solid 408. The luminescent portion 124 can be shaped as a rectangular solid 410 or as a circular rod 412.

As another embodiment of the light homogenizer 114 shown in FIG. 1, a side view of the crystal phosphor waveguide 134 can include the luminescent portion 124 abutting an input waveguide 414 used to prepare the laser light 108 before entering the crystal phosphor waveguide 134. The input waveguide 414 can include a solid glass structure, a hollow waveguide, a tapered hollow waveguide, or a combination thereof. It is understood that the input waveguide 414 can be a clear material with a reflective coating 416 around the perimeter for reflecting an incident luminous light 132 back into the luminescent portion 124. The reflective coating 416 can be a layer of liquid, gel, poly-silicon glass, a coating of silver, aluminum, magnesium oxide, barium sulfate, or any suitable material.

It has been discovered that the waveguide assembly 104 of FIG. 1 with the luminescent portion 124, such as a crystal phosphor rod, can be placed at the inside the conductive frame 402. The luminescent portion 124 can be mounted to the conductive frame 402 mechanically or using epoxy. The cooling gap 322 of FIG. 3 can also be filled with air, a transparent, heat conductive gel, liquid, or a combination thereof. The input filter 120 of FIG. 1 and output filter 138 of FIG. 1 can act to seal the cooling gap 322 in order to keep the liquid or gel inside the gap. A small air pocket (not shown) can be incorporated into the gap, not shown, such that it accommodates the thermal expansion of the air, liquid, or gel and the conductive frame 402. The conductive frame 402 can be attached to the output heat sink for increased heat dissipation. The reflective layer 416, either a reflective coating inside the phosphor heat sink or a reflective coating on the surface of the crystal phosphor rod, is included between the phosphor heat sink and the crystal phosphor rod such that light from the rod are reflected back into the rod for increase efficiency.

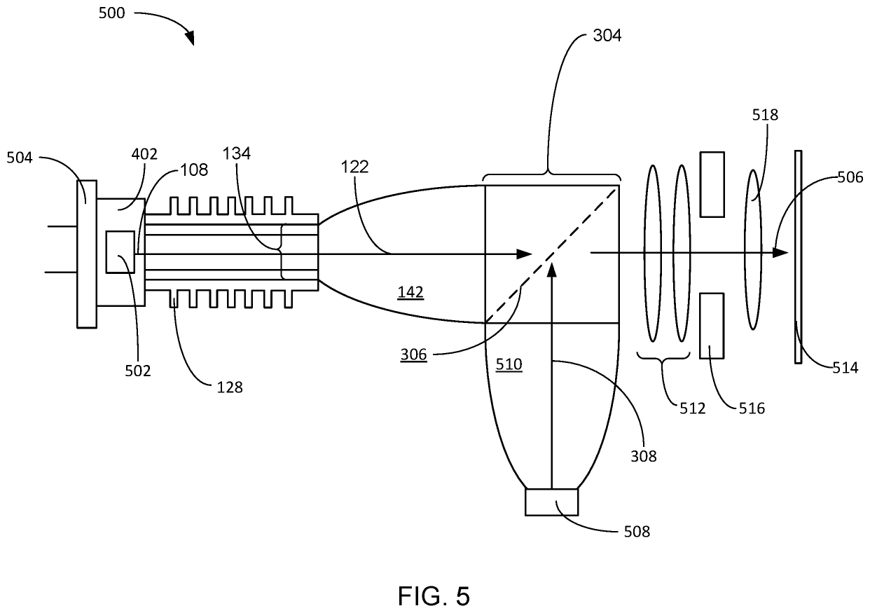

Referring now to FIG. 5, therein is shown an example of a functional block diagram of an illumination system 500 in yet another alternative embodiment. The functional block diagram of the illumination system 500 depicts a laser unit 502 mounted in the conductive frame 402 and supported by circuit adapter 504, which can be mounted on a heat sink.

For example, the circuit adapter 504 can include a printed circuit board, a flex circuit, a ceramic coupling connector, or the like used to mount the illumination system 500 in an application device (not shown). The conductive frame 402 can be surface mounted directly on the heat dissipater 128 with the laser light 108 aligned with the center of the waveguide 134. This embodiment uses the conductive frame 402 of the laser unit 502 as the input device 102 of FIG. 1.

The CPC 142 can be coupled directly on the beam combiner 304, including the reflective filter 306. By way of an example, the luminescent light 122 can be a yellow light. If a projection light 506 of white light is desired, this requires the reflective filter 306 of the beam combiner 304 be a blue reflective filter. By combining the luminescent light 122 (yellow light) with the colored light 308 (blue light), the white light can be achieved for the projection light 506. It is understood that other colors for the projection light 506 can be achieved by combining beams of different colors and frequencies.

The colored light 308 can be provided by an accent light-emitting diode (LED) 508 that can provide additional colors and specific frequencies based on the desired color of the projection light 506. The accent LED 508 can be adhered directly on a second beam CPC 510. The second beam CPC 510 can be fused directly on the beam combiner 304. The projection light 506 can exit the beam combiner 304 and pass through a set of collimating lenses 512. The collimating lenses 512 are optical devices that include surface features that accept light in a non-parallel direction and produces a light output with a parallel columns or waves evenly distributed across the optical path of the projection light 506 across a projection target surface 514.

An output aperture 516 can hold a color wheel (not shown) or act as a mount for a “goes before optics” (GOBO) (not shown). The projection light 506 that passes through the output aperture 516 can be operated on by a projection lens 518 in order to focus any image provided in the projection light 506. It is understood that the projection lens 518 can narrowly focus the projected light 506 or defocus the beam to cover more area with less brightness.

It has been discovered that the illumination system 500 can provide multiple functions by adding a GOBO or color wheel to alter the projection light 506 that is displayed on the projection target surface 514. By changing the color of the accent LED 508, different color combinations can be achieved. It is understood that the color frequencies of the laser light 108 can be modified by using a different frequency laser, by changing the color of the crystal phosphor used in the luminescent portion 124, by changing the color of the accent LED 508, by adding a color wheel, or a combination thereof.

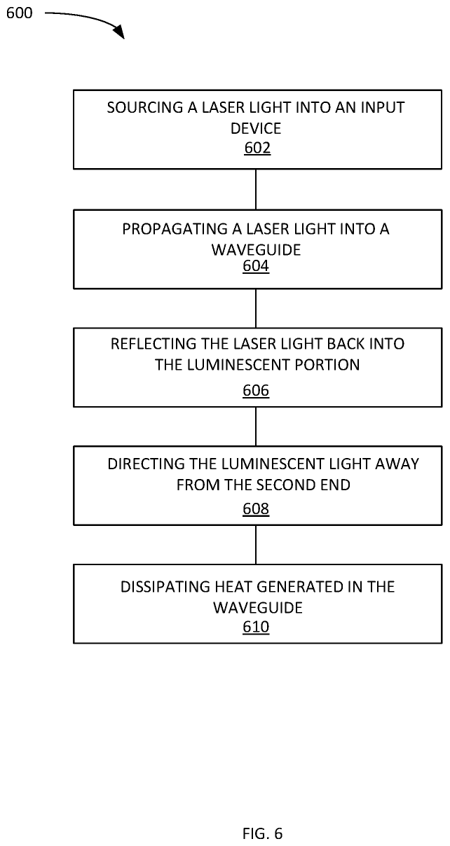

Referring now to FIG. 6, therein is shown a flow chart of a method 600 of operation of an illumination system 100 in an embodiment of the present invention. The method 600 includes: sourcing a laser light into an input device adjacent to a waveguide, the waveguide receiving the laser light through a first end, generating a luminescent light from the laser light in a luminescent portion, and passing the luminescent light through a second end in a block 602; propagating the laser light into the first end of the waveguide in a block 604; reflecting at least some of the laser light back into the luminescent portion in a block 606; directing the luminescent light away from the second end through an output surface in a block 608; and dissipating heat generated within the waveguide by the generation of the luminescent light in a block 610.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

1. An illumination system comprising:
a waveguide including:
a first end configured to receive a laser light,
a luminescent portion, including the first end, configured to generate a luminescent light from the laser light,
a second end, opposite the first end, configured to pass the luminescent light;
an input device, adjacent to the first end, configured to:
collect the laser light for propagation to the first end,
wherein the input device includes a parabolic reflector configured to focus the laser light on a light homogenizer for propagating the laser light to the first end; and
an output device, adjacent to the second end, configured to:
reflect at least some of the laser light back into the luminescent portion, and
direct the luminescent light away from the second end through an output surface.

2. The system as claimed in claim 1, further comprising a heat dissipater, adjacent to the waveguide, configured to dissipate heat generated within the waveguide by the generation of the luminescent light.

3. The system as claimed in claim 1, further comprising a heat dissipater, adjacent to the waveguide, configured to dissipate heat generated within the waveguide by the generation of the luminescent light; and
wherein:
the waveguide includes a longitudinal surface, between the first end and the second end; and
the heat dissipater is configured to:
wrap around the longitudinal surface, and
encapsulate the luminescent portion; and
the heat dissipater includes:
an interior surface adjacent the longitudinal surface, and
an intermediate layer, between the longitudinal surface and the interior surface, that is configured to:
transfer the heat away from the waveguide, and
reflect the laser light back into the luminescent portion.

4. The system as claimed in claim 1, further comprising:
a heat dissipater, adjacent to the waveguide, configured to dissipate heat generated within the waveguide by the generation of the luminescent light; and
an intermediate layer, between the luminescent portion and the heat dissipater, configured to dissipate the heat generated within the waveguide through a fluid.

5. The system as claimed in claim 1, further comprising a heat dissipater, adjacent to the waveguide, configured to dissipate heat generated within the waveguide by the generation of the luminescent light, wherein the heat dissipater includes a thermally conductive frame, with an interior surface adjacent to the luminescent portion, configured to transfer the heat from the waveguide.

6. The system as claimed in claim 1, further comprising a heat dissipater, adjacent to the waveguide, configured to dissipate heat generated within the waveguide by the generation of the luminescent light, wherein the heat dissipater includes an intermediate layer formed of a reflective material, in contact with an interior surface of a heatsink and a longitudinal surface of the luminescent portion.

7. The system as claimed in claim 1, wherein the input device includes a light homogenizer, including a light pipe, a glass tube, or a light tube, configured to spatially uniformly distribute a light intensity of the laser light at the first end of the waveguide.

8. (canceled)

9. An illumination system comprising:
a waveguide including:
a first end configured to receive a laser light,
a luminescent portion, including the first end, configured to generate a luminescent light from the laser light,
a second end, opposite the first end, configured to pass the luminescent light;
an input device, adjacent to the first end, configured to:
collect the laser light for propagation to the first end;
an output device, adjacent to the second end, configured to:
reflect at least some of the laser light back into the luminescent portion, and
direct the luminescent light away from the second end through an output surface, wherein:
the waveguide includes a cross section of the first end matching an output cross section of the input device; and
the input device includes:
an input cross section larger than the cross section, and
a parabolic reflector configured to direct the laser light from a laser array to the input cross section.

10. The system as claimed in claim 1, wherein:
the input device includes an input filter, proximate the first end, configured to:
pass the laser light to the first end and reflect the luminescent light back to the second end; and
the output device includes:
an output filter, proximate the second end of the waveguide, configured to:
pass the luminescent light sourced from the waveguide, and
reflect at least some of the laser light back into the luminescent portion; and
a compound parabolic concentrator (CPC), proximate the output filter, configured to concentrate the luminescent light sourced from the waveguide.

11. An illumination system comprising:
a waveguide including:
a first end configured to receive a laser light,
a luminescent portion, including the first end, configured to generate a luminescent light from the laser light,
a second end, opposite the first end, configured to pass the luminescent light;
an input device, adjacent to the first end, configured to:
collect the laser light for propagation to the first end;
an output device, adjacent to the second end, configured to:
reflect at least some of the laser light back into the luminescent portion, and
direct the luminescent light away from the second end through an output surface, wherein:
the laser light includes a first blue light;
the luminescent light includes a yellow light; and
the output device includes a beam combiner configured to:
receive the yellow light sourced from the waveguide,
receive a colored light comprising one of a blue LED light and the first blue laser light,
combine the yellow light and the colored light to form a projection light of white light, and
direct the projection light of the white light to a projection target surface.

12. An illumination system comprising:
a waveguide including:
a first end configured to receive a laser light,
a luminescent portion, including the first end, configured to generate a luminescent light from the laser light,
a second end, opposite the first end, configured to pass the luminescent light;
an input device, adjacent to the first end, configured to:
collect the laser light for propagation to the first end;
an output device, adjacent to the second end, configured to:
reflect at least some of the laser light back into the luminescent portion, and
direct the luminescent light away from the second end through an output surface, wherein the output device includes a beam combiner configured to:
pass the luminescent light as a yellow light through a reflective filter;
reflect at least some of the laser light as a blue laser light to the first end of the waveguide;
combine the yellow light and at least some of the blue light to form a white projection light; and
direct the white projection light to a projection target surface.

13. A method for operating an illumination system, the method comprising:
sourcing a laser light into an input device adjacent to a waveguide, including:
receiving a laser light through a first end of the waveguide,
generating a luminescent light from the laser light in a luminescent portion,
passing the luminescent light through a second end, opposite to the first end;
propagating the laser light into the first end of the waveguide;
reflecting at least some of the laser light back into the luminescent portion;
directing the luminescent light away from the second end through an output surface;
passing the luminescent light as a yellow light through a reflective filter;
reflecting at least some of the laser light as a blue laser light to the first end of the waveguide;
combining the yellow light and at least some of the blue light to form a white projection light; and
directing the white projection light to a projection target surface; and
dissipating heat generated within the waveguide by the generation of the luminescent light.

14. The method as claimed in claim 13, further comprising:
transferring heat generated within the waveguide through a heat dissipater and an intermediate layer encapsulating the luminescent portion, wherein the intermediate layer is located between a longitudinal surface of the waveguide and an interior surface of the heat dissipater; and
reflecting the laser light back into the luminescent portion.

15. The method as claimed in claim 13, wherein dissipating the heat generated within the waveguide includes transferring the heat with an intermediate layer formed of a reflective material, in contact with an interior surface of a heatsink and a longitudinal surface of the luminescent portion.

16. The method as claimed in claim 13, wherein reflecting at least some of the laser light includes dissipating the heat generated within the waveguide with an intermediate layer, between the luminescent portion and the heat dissipater, through a fluid.

17. The method as claimed in claim 13, wherein sourcing the laser light into the input device adjacent to the waveguide includes sourcing the laser light into a light homogenizer, including a light pipe, a glass tube, or a light tube, and the light homogenizer spatially uniformly distributing a light intensity of the laser light at the first end of the waveguide.

18. The method as claimed in claim 13, wherein directing the luminescent light away from the second end through the output surface includes:
passing the luminescent light sourced from the second end through an output filter, proximate the second end; and
concentrating the luminescent light with a compound parabolic concentrator (CPC) proximate the output filter.

19. (canceled)

20. A method for operating an illumination system, the method comprising:
sourcing a laser light into an input device adjacent to a waveguide, including:
receiving a laser light through a first end of the waveguide,
generating a luminescent light from the laser light in a luminescent portion,
passing the luminescent light through a second end, opposite to the first end;
propagating the laser light into the first end of the waveguide;
reflecting at least some of the laser light back into the luminescent portion;
directing the luminescent light away from the second end through an output surface, wherein the directing the luminescent light away from the second end through the output surface includes passing the luminescent light through an output filter proximate the second end;
positioning an output filter, abutting the second end and along an axial centerline extending between the first end and the second end, at first angle relative to the axial centerline;
sourcing a blue light into the output filter through a light pipe, at a second angle relative to the axial centerline, the light pipe disposed adjacent to a reflective filter and separated from the reflective filter by a gap; and
dissipating heat generated within the waveguide by the generation of the luminescent light.

21. The method as claimed in claim 20, wherein the sourcing of the laser light into the input device adjacent to the waveguide includes sourcing the laser light into a light homogenizer, including a light pipe, a glass tube, or a light tube, and the light homogenizer spatially uniformly distributing a light intensity of the laser light at the first end of the waveguide.

22. The system as claimed in claim 12, wherein the input device includes:
a light homogenizer; and
a parabolic reflector configured to focus the laser light on the light homogenizer that propagated the laser light to the first end of the waveguide.
